(19) United States
(12) Patent Application Publication
(10) Pub. No.: US 2006/0152017 A1
(43) Pub. Date: Jul. 13, 2006

(54) Reversing linkage

(76) Inventor: Simon Powell, Herts (GB)

Correspondence Address: Edward G Greive;Renner Kenner Greive, Bobak Taylor & Weber, Fourth Floor, First National Tower, Akron, OH, 44308-1456, US

(21) Appl. No.: 10/523,670

(22) PCT Filed: Jul. 30, 2003
(86) PCT No.: PCT/GB03/03277

§ 371 Date: Oct. 31, 2005

(30) Foreign Application Priority Data
Jul. 31, 2002 (GB) 0217734.3

(51) Int. Cl. E05C 21/00

(52) U.S. Cl. 292/1

(57) ABSTRACT

A linkage mechanism comprising a moveable member mounted for movement with respect to a fixed member to which it is connected. The moveable member is provided with first and second elements spaced from each other with one element constituting a moveable element while the other constitutes a datum element. The relative movement between the moveable member and the fixed member is achieved by means which are located and arranged to preferentially utilise the first of the spaced elements as the datum with respect to which the second element is moved. The mechanism further comprises a means for selectively inhibiting movement of the second element which is preferably electrically controlled, whereby to cause the second element to become the datum. The linkage mechanism may be utilised in a door lock.

The present invention relates to a reversing linkage and more particularly to an electrically controlled reversing linkage. By a reversing linkage we mean a linkage in which input motion in a first direction will result in output motion in either the first direction or a second opposite direction.

It is an object of the present invention to provide a reversing linkage which is simple to construct, reliable in operation and can be readily controlled.

Accordingly, the present invention provides a linkage mechanism comprising:

a moveable member mounted for movement with respect to a fixed member to which it is connected and which constrains movement of the moveable member, the moveable member being provided with first and second elements spaced form each other and one of which constitutes a moveable element while the other constitutes a datum element;

means for causing relative movement between the moveable member and the fixed member, said means being located and arranged whereby to preferentially utilise the first of the spaced elements as the datum with respect to which the second element is moved; and

means for selectively inhibiting movement of said second element whereby to cause the second element to become the datum with respect to which the first element is moved.

Such a linkage has a large variety of uses and, for example, could be used in the high speed yarn transfer system disclosed in our earlier co-pending UK Application No 0122406.2 or in the lock mechanism disclosed in our earlier co-pending UK Application No 0208508.2.

In order that the present invention be more readily understood, an embodiment thereof will now be described by way of example with reference to the accompanying drawings, in which:—

FIG. 1 is an exploded perspective view of a reversing linkage according to the present invention;

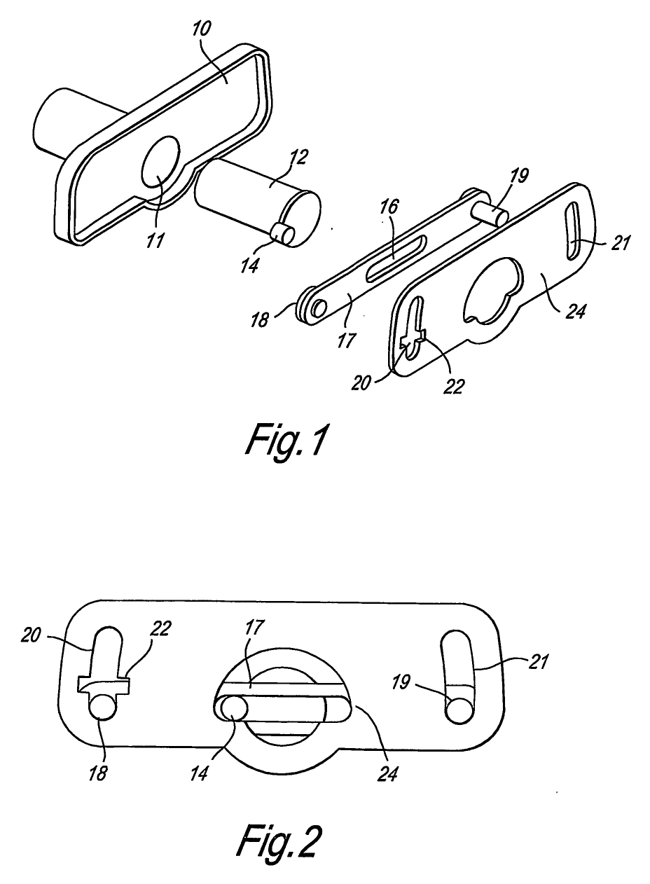

FIG. 2 is a front view of the linkage of FIG. 1 in a first condition;

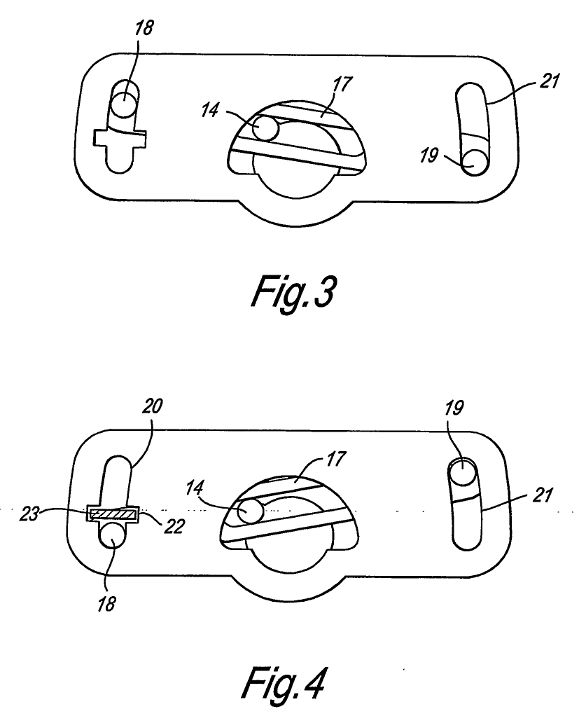

FIG. 3 is a front view of the linkage of FIG. 1 in a second condition; and

FIG. 4 is a front view of the linkage of FIG. 1 in a third condition.

A preferred embodiment will now be described as a “smart” lock ie one which requires both mechanical and electrical actuation before it will operate. This is but one use of the linkage, which with minor alterations could be used for a number of purposes.

Referring now to FIG. 1, this shows an exploded perspective view of a part of a door lock. It comprises a base member 10 provided with a base 11 which reviews a one end of barrel 12. The other end of the barrel is provided with an actuator pin 14 which is provided at a position which is radially offset from the axis of rotation of the barrel 12.

The pin 14 is received in a slot 16 in a link arm 17. The slot is positioned at a suitable location in the arm 17 depending on the design of the lock and the forces required but in this case it is generally, centrally located between two pins 18 and 19. In this case, the pin 19 is longer than the pin 18 but this need not be the case and will again depend on the exact design of the remainder of the lock.

The pins 18,19 on the link arm 17 are received in respective slots 20,21 in a face-plate 24 which is fixed on the base member 10. The slot 20 is provided with a cross-slot 22 whose purpose will be explained later.

Although not shown in the Figure, the base member 10 is fixed and receives the faceplate 24. The shape of the faceplate is such that the faceplate remains fixed with the base member even when movement of the barrel 12 and link arm 17 occurs. The link arm is preferably arranged between the base 11 of the base member 12 and the faceplate 24.

Turning now to FIG. 2, this shows the lock of FIG. 1 in an assembled condition and the same reference numerals are used for the same part. FIG. 2 shows the device at rest in its datum position with the pin 19 biased to the position shown by a spring between the pin 14 on the barrel 12 and the pin 19.

An electrically operated device such as a piezo electric actuator sits above the mechanism and is arranged such that it will cause insertion into and rejection from the cross-slot 22 of a blocking member 23. The member is a good fit into the cross-slot 22 and interferes with its movement of the pin 18 away from its rest position as shown in FIG. 2.

In FIG. 3, again the same parts use the same reference numerals but here the barrel 12 has been rotated in a clockwise direction. This has caused the link arm 17 to pivot in a clockwise direction about the pin 19 which in turn has caused the pin 18 to rise in the slot 20 in view of the fact that there is no blocking member in the cross-slot 22. Thus, if the pin 19 is used as an output member for the lock, rotation of the barrel 12 has not resulted in any movement of the pin 19.

However, if the blocking member is present in the cross-slot 22, movement of the pin 18 in the slot 20 is inhibited and so rotation of the barrel 12 in a clockwise direction will result in the link arm being forced to pivot in an anti-clockwise direction to raise the pin 19 in the slot 21 as shown in FIG. 4.

The slots 20,21 of the face plate 24 are shown in the diagram as arcuate in shape. However, the slots may be linear and may also be of any length and width. Additionally, the slots 20,21 do not necessarily have to be of the same dimensions.

In addition, the Figures show the movement of the actuator pin to move to approximately 45° from the datum position. However, the mechanism is not limited to such motion and the degree of radial movement may increase or decrease. For example, complete reciprocation of pin 18 within the slot 20 may be possible if the degree of rotation of the barrel 12 is increased.

In the above described preferred embodiment, the faceplate 24 receives the actuator pin 14 of the barrel 12 in an opening which is shaped such as to allow a certain degree of radial movement of the actuator pin with respect to the opening. It will be appreciated that the shape of the opening is not limited to that shown in the Figures and that any suitable opening may be utilised which allows the mechanism to operate to produce the desired result. In particular, the opening may be in the shape of a groove which receives the actuator pin 14 and constrains the movement of the pin.

It will be appreciated that other various modifications may be made to the above mechanism. For example, the pin 18 as well as the pin 19 could be used as an output which would mean that motion in one direction of the barrel 12 could be translated into motion in one or other direction depending on the state of actuation of the electrically operated device. Also, the barrel could be replaced by a slider such as might be used in a locking bolt or by a cam that is connected to a key barrel thus providing a lock that requires both a mechanical key and an electronic signal to operated.

1. A linkage mechanism comprising:
a moveable member mounted for movement with respect to a fixed member to which it is connected and which constrains movement of the moveable member, the moveable member being provided with first and second elements spaced from each other and one of which constitutes a moveable element while the other constitutes a datum element;
means for causing relative movement between the moveable member and the fixed member, said means being located and arranged whereby to preferentially utilise the first of the spaced elements as the datum with respect to which the second element is moved; and
means for selectively inhibiting movement of said second element whereby to cause the second element to become the datum with respect to which the first element is moved.

2. The linkage mechanism according to claim 1 wherein the means for utilising relative movement includes an arcuately moveable member.

3. The linkage mechanism according to claim 2 wherein the fixed member is arranged to constrain movement of the spaced elements by receiving them in slots or grooves.

4. The linkage mechanism according to claim 3 wherein the slots or grooves are arcuate.

5. The linkage mechanism according to claim 4 wherein the means for selectively inhibiting movement is electrically controlled.

6. The linkage mechanism according to claim 1 wherein the means for selectively inhibiting movement includes a piezo-electric actuator.

7. (canceled)

8. A door lock utilising the linkage mechanism according to claim 1.

9. The linkage mechanism according to claim 1 wherein the fixed member is arranged to constrain movement of the spaced elements by receiving them in slots or grooves.

10. The linkage mechanism according to claim 9 wherein the slots or grooves are arcuate.

11. The linkage mechanism according to claim 1 wherein the means for selectively inhibiting movement is electrically controlled.
